(19) United States
(12) Patent Application Publication
(10) Pub. No.: US 2026/0073416 A1
(43) Pub. Date: Mar. 12, 2026

(54) SYSTEM AND METHOD TO FORECAST INCOME AND EXPENDITURES DISTRIBUTIONS

(71) Applicant: World Data Lab WDL GmbH, Vienna (AT)

(72) Inventors: Homi Kharas, Chevy Chase, MD (US); Jesus Crespo Cuaresma, Vienna (AT); Katharina Fenz, Vienna (AT); Wolfgang Fengler, Vienna (AT)

(73) Assignee: World Data Lab WDL GmbH, Vienna (AT)

(21) Appl. No.: 18/826,861

(22) Filed: Sep. 6, 2024

(51) Int. Cl. G06Q 30/0204; G06Q 40/06

(52) U.S. Cl. CPC G06Q 30/0205; G06Q 40/06

(57) ABSTRACT

Particular example embodiments described herein can provide for a system, an apparatus, and a method for collecting household income and expenditures data for a country, extending the household income and expenditures data for the country for each year in a period of time, collecting distribution demographic data for the country, extending the distribution demographic data for the country for each year in the period of time, and merging the household income and expenditures data and the distribution demographic data for the country to create a report forecasting income and expenditures distributions for the country.

### TECHNICAL FIELD

This disclosure relates in general to the field of computing and, more particularly, to a system, an apparatus, and a method to enable forecasting income and expenditures distributions.

### BACKGROUND

Financial forecasting, also known as budget forecasting, is a process that helps countries predict financial metrics to plan for future success. Financial forecasting can help countries set goals, anticipate market conditions, and make informed decisions based on expected outcomes. In addition, financial forecasting can help set economic policies that promote financial stability and monetary cooperation, which are essential to increase economic well-being of a country.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to enable forecasting of income and expenditures distributions, in accordance with an embodiment of the present disclosure;

FIG. 2 is a simplified block diagram of a particular implementation of an income and expenditures per household engine to help enable forecasting of income and expenditures distributions, in accordance with an embodiment of the present disclosure;

FIG. 3 is a simplified block diagram of a particular implementation of an income and expenditures per household engine to help enable forecasting of income and expenditures distributions, in accordance with an embodiment of the present disclosure;

FIG. 4 is a simplified block diagram of a particular implementation of a merger engine to help enable forecasting of income and expenditures distributions, in accordance with an embodiment of the present disclosure;

FIG. 5 is a simplified block diagram of a particular implementation of a database to help enable forecasting of income and expenditures distributions, in accordance with an embodiment of the present disclosure;

FIG. 6 is a simplified flowchart illustrating potential operations to validate data to help enable forecasting of income and expenditures distributions, in accordance with an embodiment of the present disclosure;

FIG. 7 is a simplified flowchart illustrating potential operations to help enable forecasting of income and expenditures distributions, in accordance with an embodiment of the present disclosure;

FIG. 8 is a simplified flowchart illustrating potential operations to determine a total income and expenditures of households in a country for a predetermined time range to help enable forecasting of income and expenditures distributions, in accordance with an embodiment of the present disclosure;

FIG. 9 is a simplified flowchart illustrating potential operations to determine a distribution of income and expenditures for households in continuous percentages steps to help enable forecasting of income and expenditures distributions, in accordance with an embodiment of the present disclosure;

FIG. 10 is a simplified flowchart illustrating potential operations to determine a distribution of total income and expenditures for all years or a predetermined time range to help enable forecasting of income and expenditures distributions, in accordance with an embodiment of the present disclosure;

FIG. 11 is a simplified flowchart illustrating potential operations to help ensure the distribution of household income and household expenditures in a country is relatively accurate to help enable forecasting of income and expenditures distributions, in accordance with an embodiment of the present disclosure;

FIG. 12 is a simplified flowchart illustrating potential operations to parametrize income distributions and expenditure distributions and convert the distributions to a common currency to help enable forecasting of income and expenditures distributions, in accordance with an embodiment of the present disclosure

FIG. 13 is a simplified flowchart illustrating potential operations to determine a distribution of income and expenditures for a specific demographic to help enable forecasting of income and expenditures distributions, in accordance with an embodiment of the present disclosure;

FIG. 14 is a simplified flowchart illustrating potential operations to break the distribution of income and expenditures for a specific demographic into percentage steps to help enable forecasting of income and expenditures distributions, in accordance with an embodiment of the present disclosure;

FIG. 15 is a simplified flowchart illustrating potential operations to merge the distribution of income and expenditures for a specific demographic with the distribution of total income and expenditures for households in a country to help enable forecasting of income and expenditures distributions, in accordance with an embodiment of the present disclosure;

FIG. 16 is a simplified flowchart illustrating potential operations to generate a new report to help enable forecasting of income and expenditures distributions, in accordance with an embodiment of the present disclosure;

FIG. 17 is a simplified flowchart illustrating potential operations to generate a report to help enable forecasting of income and expenditures distributions, in accordance with an embodiment of the present disclosure;

FIG. 18 is a simplified block diagram illustrating example details of an example computer model inference and computer model training to help enable forecasting income and expenditures distributions, in accordance with an embodiment of the present disclosure; and

FIG. 19 is a simplified block diagram illustrating examples details of an example neural network architecture to enable forecasting income and expenditures distributions, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling forecasting income and expenditures distributions, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an illustrative example, a system, method, apparatus, means, etc. to help enable forecasting income and expenditures distributions can include a prediction and forecast electronic device. The prediction and forecast electronic device can include an income and expenditure per household engine, a distribution of income and expenditures engine, and a merger engine. In an illustrative example, the prediction and forecast electronic device can obtain data from one or more data sources to help enable forecasting income and expenditures distributions.

More specifically, the prediction and forecast electronic device can obtain data from one or more of the International Monetary Fund (IMF), World Bank (WB), Organization for Economic Co-operation and Development (OECD), International Income Distribution Database (I2D2), International Institute for Applied Systems Analysis (IIASA), or some other data source. In some examples, the data is verified if possible. Once the data from one or more data sources is received, the data is harmonized in order to be able to compare forecasted income and expenditures between countries. To harmonize the income and expenditures of different countries, the income and expenditure of each country can be broken down into percentage steps such that the income and expenditures of a certain percentage (the poorest 5%) is “X” percent. The income and expenditure of each country is estimated for a future predetermined time range (e.g., 50 years).

In addition, the demographics of the country can be broken down into percentage steps such that a specific demographic represents “Y” percent of the population of the country (e.g. young men represent 35% of the poorest 5% in the country). By applying demographic distributions to predicted future income and expenditures, the system is able to forecast income and expenditures distributions for the country for specific demographics. Because the income distributions and expenditure distributions for the country were broken down into percentage steps, different countries can be compared with each other, even if the different countries rely on different currencies.

### Example Systems, Apparatuses, and Methods

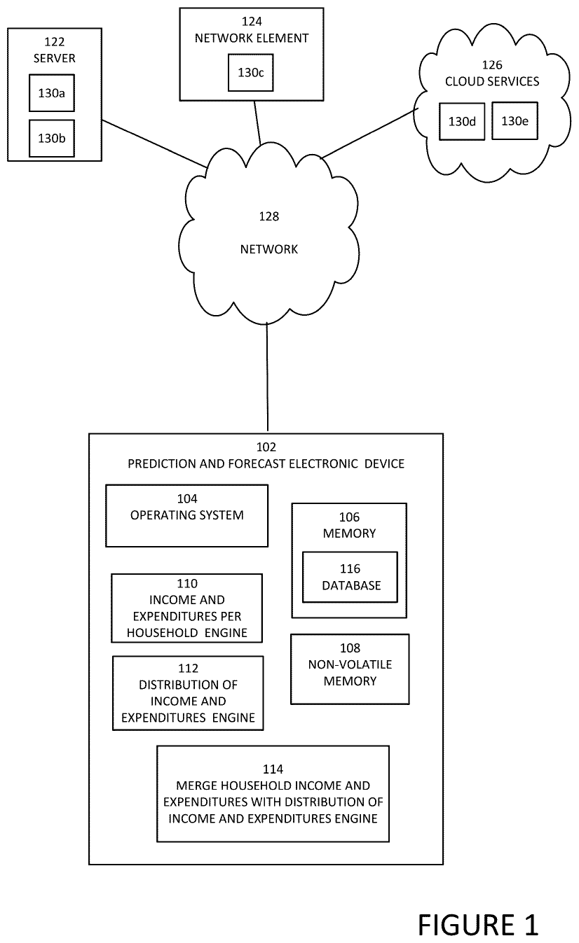

FIG. 1A is simplified block diagram of a particular non-limiting system 100 to enable forecasting income and expenditures distributions. The system 100 can include a prediction and forecast electronic device 102. The prediction and forecast electronic device 102 can include an operating system 104, memory 106, non-volatile memory 108, an income and expenditure per household engine 110, a distribution of income and expenditures engine 112, and a merger household income and expenditures with distribution of income and expenditures engine 114. The memory can include a database 116.

In an illustrative example, the prediction and forecast electronic device 102 can be in communication with one or more servers 122, one or more network elements 124, and/or cloud services 126 using network 128. Each of the server 122, the network element 124, and cloud services 126 can include one or more data sources 130. For example, the server 122 includes data sources 130a and 130b, the network element includes data source 130c, and cloud services includes data sources 130d and 130e. The data sources 130 include data that can be used by the prediction and forecast electronic device 102 to help enable forecasting income and expenditures distributions.

In an illustrative example, to forecast income and expenditures distributions for a country, the prediction and forecast electronic device 102 can communicate with one or more of the server 122, the network element 124, and/or cloud services 126 to obtain one or more data sources 130 that are related the income and expenditure distributions of the country as well as to the GDP growth rate of the country. The household expenditure rate for the country is allowed to grow with the GDP growth rate. In addition, the prediction and forecast electronic device 102 can communicate with one or more of the server 122, the network element 124, and cloud services 126 to obtain one or more data sources 130 that are related to national accounts data and determine the savings rate for the country.

The income and expenditures per household engine 110 in the prediction and forecast electronic device 102 can create continuous income and expenditures distributions based off of the forecasted expenditure and the savings rate of the country. In some examples, the income and expenditures are broken down into one percent (1%) steps such that the poorest one percent (1%) income and expenditures is determined (for example, the poorest has 0.2 of the total expenditures) all the way up to one-hundred percent (100%). The one percent (1%) steps provide data at all percentages from one percent (1%) to one hundred percent (100%). Note that the data from the one or more data sources 130 typically does not include all the percentages. By breaking down the income and expenditures into one percent (1%) steps, the income and expenditures for a specific country can be homogenized or harmonized to allow for comparison with other countries.

In addition, using the distribution of income and expenditures engine 112, the prediction and forecast electronic device 102 can communicate with one or more of the server 122, the network element 124, and cloud services 126 to obtain one or more data sources 130 that are related to demographic information of people in the country. In some examples, the data is survey data related to demographic information of people in the country. The national distribution of income and expenditures of people in the country is broken down into percentage steps (e.g., 5% steps) to identify the expenditures or income levels of the poorest five percent (5%), the poorest ten percent (10%), etc. Then the people in the survey are grouped into one of the percentage steps. Each person's weight (the number of people in the population of the country that the person represents) in the survey is aggregated to allow each person in the survey to represent a portion of the population of the country with the same demographics. In some examples, the weight of each person is aggregate by the percentages, the brackets in the distribution, as well as by the demographics represented by the survey. For each demographic group, the share of the demographic group in each percentage step is determined. For example, for each demographic group, the system determines what share of that group is in the poorest 5%, the next 5% and so on (e.g., 6% of a specific demographic group is in a specified 5% step). By determining the share of the demographic group in each percentage step, the demographic data can be compared with the national data and the forecasted income and expenditures of the national population that was broken into one percent (1%) steps can be used to forecast income and expenditures distributions for a specific demographic of people in a country.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable gathering information related to forecasting income and expenditures distributions, the following foundational information may be viewed as a basis from which the present disclosure may be properly explained. Financial forecasting is predicting a country's financial future by examining historical performance data. The financial forecast can be used to help predict the overall health and stability of a country including national accounts, inflation, unemployment rates, balance of payments, fiscal indicators, and other health and stability indicators. The financial forecast can also be used by businesses to help determine new market opportunities. One way to perform financial forecasting of a country is to determine the income and expenditures distributions of the country. However, currently there is not an accurate system, apparatus, or method to help enable forecasting income and expenditures distributions of a country. What is needed is a system, an apparatus, and a method to help enable forecasting income and expenditures distributions of a country.

A system, method, apparatus, means, etc. to help enable forecasting income and expenditures distributions of a country can help resolve these issues (and others). In an example, a system and method can include a prediction and forecast electronic device (the prediction and forecast electronic device 102). The prediction and forecast electronic device can include an income and expenditure per household engine (e.g., the income and expenditure per household engine 110), a distribution of income and expenditures engine (e.g., the distribution of income and expenditures engine 112), and a merger engine (e.g., the merger household income and expenditures with distribution of income and expenditures engine 114). In an illustrative example, the prediction and forecast electronic device can obtain data from one or more data sources (e.g., the one or more data sources 130) to help enable forecasting income and expenditures distributions.

In an example, the prediction and forecast electronic device can obtain data from one or more of the International Monetary Fund (IMF), World Bank (WB), Organization for Economic Co-operation and Development (OECD), International Income Distribution Database (I2D2), International Institute for Applied Systems Analysis (IIASA), or some other data source. Once the data from one or more data sources is received, the data is formatted and verified if possible. In one example, if the data is obtained from more than one source, each of the data is compared to the other data to check for discrepancies. In some cases, multiple data sets can be averaged to generate one data set.

After the data is obtained, the data is used to generate GDP growth rates for the country. To predict household expenditures in the country, the total income distributions and total expenditure distributions of the country are determined and are increased in line with the growth rate of GDP. In some examples, a savings rate is determined and applied to estimate incomes based on expenditure. The income distributions and expenditure distributions of the country are broken down into percentage increments. In a specific example, income distributions and expenditure distributions of the country are brought into 0.1% increments (the poorest 0.1% of the population have x % of total income, the poorest 0.2% have y % of total income, etc.).

For countries with missing income distributions or expenditure distributions linear regressions are used to forecast missing income distributions or expenditure distributions. For example, income distributions for countries with no income distributions data are forecasted using expenditure distributions data. For countries with no expenditure distributions data, the expenditure distributions are forecasted using income distributions data. For countries with no income distributions data and no expenditure distributions data, another country with similar socioeconomics is used to forecast the income distributions and the expenditure distributions for the country. In some examples, a machine learning model, or computer model, is trained to use socioeconomic data to forecast a country's total household income and expenditure and the trained machine learning model, or the computer model, can be used to forecast missing household income distributions and expenditure distributions. Distributions of household income and expenditures are adjusted such that the sum of household income and expenditure from the distribution equals the total income and expenditure of the country. Income distributions and expenditure distributions for years between observations are interpolated and income distributions and expenditure distributions are kept constant for future years after the last observation.

Once determined, the income distributions and expenditure distributions are abstracted in a compact way using parameters. For example, linear regressions can be used to estimate three parameters that describe each income distribution and expenditure distribution for the country. The income distributions and expenditure distributions are converted into a common monetary increment (e.g., one-dollar ($1) increments) using the total income distribution and expenditure distribution for the country and the parameters (e.g., x people have an income of $0-1 per day, y people have an income of $1-2 per day, etc.) In addition, survey data that includes demographics (e.g., age, gender, education, household size, residence location, or some other demographic) of the respondents from the country (e.g., from the I2D2), is broken down into percentage increments (e.g., 5%) of income distributions and expenditure distributions (e.g., the poorest 5% of the population have a maximum income of x, the poorest 10% of the population have a maximum income of y, etc.). Respondents are assigned to the percentage increments of the distribution according to their income or expenditures to determine the number of people in each percentage step by their demographic. The share in each percentage step of the income or expenditure distribution is calculated for each demographic group by age and gender, or some other demographic (x % of a demographic group is in the poorest 5%, y % of the same demographic group is in the next 5%, etc.). The increments in the national distributions are converted into a single monetary increment (e.g., in $1 increments) and applied to the proportions of demographic groups to the corresponding single monetary groups to calculate individuals and income or expenditures of each group by the single monetary increments. The share in each percentage step of the income or expenditure distribution is rescaled to match the total distributions of household income distributions and expenditure distributions of the country.

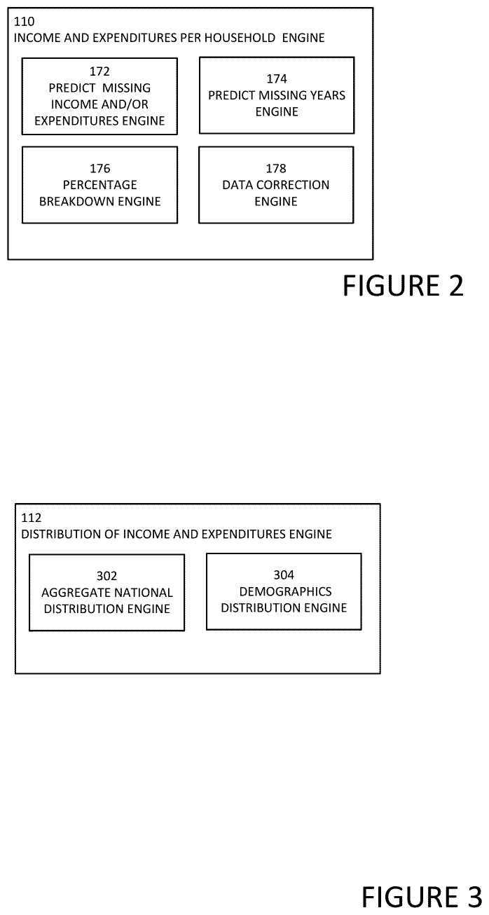

Turning to FIG. 2, FIG. 2 is a simplified block diagram illustrating example details of a particular non-limiting implementation of the income and expenditures per household engine 110 of FIG. 1. The income and expenditures per household engine 110 can include a predict missing income and/or expenditures engine 202, a predict missing years engine 204, a percentage breakdown engine 206, and a data correction engine 208.

The predict missing income and/or expenditures engine 202 can be configured to predict missing income and/or expenditures during a predetermined time range. More specifically, for countries with household expenditure data but missing household income data, the household expenditure distributions can be linked to the household income using linear regressions to forecast the missing household income data in the country. For countries with household income data but missing household expenditure data, the household income can be linked to the household expenditure using linear regressions to forecast the missing household expenditure data in the country. For countries with both missing household income data and missing household expenditure data, known household income data and/or household expenditure data from one or more countries with similar socioeconomic data can be used to estimate the missing household income data and/or the missing household expenditure data.

The predict missing years engine 204 can be configured to predict the data for years during the predetermined time range that do not include the data. For example, interpolation of the household income and the household expenditure distributions in the country can be used to predict income distributions and expenditure distributions during years of the predetermined time period where the data is missing.

The percentage breakdown engine 206 can be configured to use the total income and expenditure of the country and break it down into the income distributions and expenditure distributions for the country in percentage increments (e.g., 0.1% increments or some other percentage increment). More specifically, the total income and expenditure of the country can be broken down such that a first percentage increment of the population of the country has X percent of the total income of the country (e.g., the poorest 0.1% of the population of the country has 0.05% of the total income), the next second percentage increment of the population of the country has Y percent of the total income (e.g., the poorest 0.2% of the population of the country has 0.1% of the total income), the third percentage increment of the population of the country has Z percent of the total income (e.g., the poorest 0.3% of the population of the country has 0.15% of the total income), etc.

The data correction engine 208 can be configured to adjust distributions of household income and expenditures such that the sum of household income and expenditures from the distribution equals the total income and expenditure for the country. In a specific example, the data correction engine 208 can be configured to adjust distributions of household income and expenditures using a weighted adjustment as opposed to a linear adjustment because if the whole distribution or all the household income distributions and expenditure distributions were scaled up linearly to match the total income and expenditure for the country, there would not be any poor people in the country because everybody was shifted up. Instead, extra expenditures are added to the households with higher income or expenditure such that the higher a household's income or expenditure, the more it is shifted up. The process can be iteratively repeated to shift the upper end more and more until the sum of all the household income and expenditure from the corresponding distributions is equal to the total income and expenditure for the country.

Turning to FIG. 3, FIG. 3 is a simplified block diagram illustrating example details of a particular non-limiting implementation of the distribution of income and expenditures engine 112 of FIG. 1. The distribution of income and expenditures engine 112 can include an aggregate national distribution engine 302 and a demographics distribution engine 304.

The aggregate national distribution engine 302 can be configured to aggregate respondents to a survey of people in the country to allow the population of the country to be represented by each person that responded to the survey. More specifically, the survey may be a survey that creates survey data related to demographic information of people in the country. The national distribution of income and expenditures of people in the country can be broken down into percentage steps (e.g., 5% steps) to identify the expenditures or income levels of the poorest five percent (5%), poorest ten percent (10%), etc. Then the people in the survey are grouped into one of the percentage steps such that the whole population is fit into the brackets and such that there is a portion of the population in each bracket. Each person's weight (the number of people in the population of the country that the person represents) in the survey is aggregated to allow the population of the country to be represented by each person in the survey.

The demographics distribution engine 304 can be configured to determine the percentage share of each demographic. For example, the weight of each person is aggregate by the percentages, the brackets in the distribution, as well as by the demographics represented by the survey. Then for each demographic, the share of the demographic in each percentage step is determined. For example, for each demographic group, the demographics distribution engine 304 determines what share of that group is in the poorest 5%, the next 5% and so on (e.g., 6% of a specific demographic group are in a specified 5% step). By determining the share of the demographic group in each percentage step, the demographic data can be compared with the national data and the forecasted income and expenditures of the national population that was broken into one percent (1%) steps can be used to forecast income and expenditures distributions for a specific demographic of people in a country.

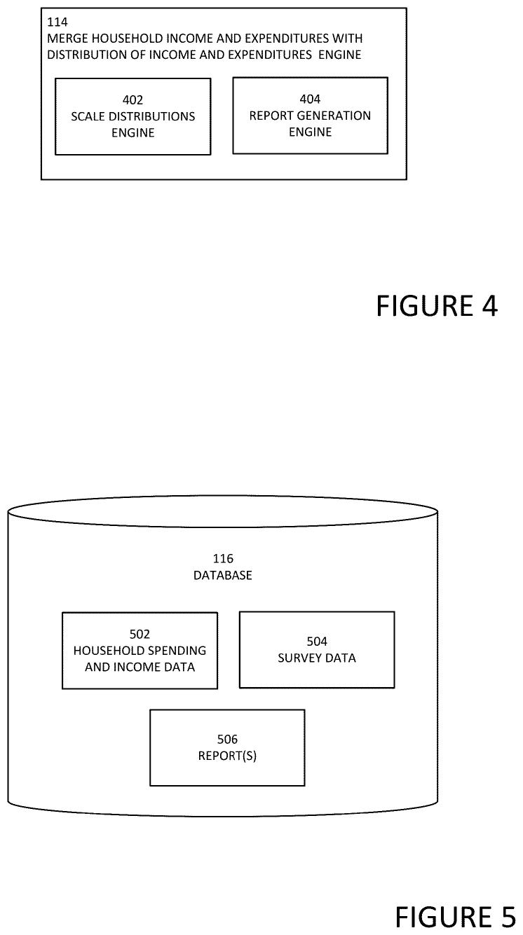

Turning to FIG. 4, FIG. 4 is a simplified block diagram illustrating example details of a particular non-limiting implementation of the merge household income and expenditures with distribution of income and expenditures engine 114 of FIG. 1. The merge household income and expenditures with distribution of income and expenditures engine 114 can include a scale distributions engine 402 and a report generation engine 404.

The scale distributions engine 402 can be configured to merge the distribution of income and expenditures for the households in continuous percentage steps with the percentage steps of the determined distribution of income and expenditures for a specific demographic to create a distribution of income and expenditures for a specific demographic. For example, the scale distributions engine 402 can be configured to scale and merge the distribution of income and expenditures for the households in continuous percentage steps with the percentage steps of the determined distribution of income and expenditures for a specific demographic to create a distribution of income and expenditures for a specific demographic. The scaling helps to ensure the determined distribution of income and expenditures for a specific demographic matches the distribution of income and expenditures for the households.

The scaling is performed iteratively until the distribution of income and expenditures for the households in continuous percentage steps is approximately equal to the percentage steps of the determined distribution of income and expenditures for a specific demographic. In a specific example, a matrix may be used where the row sums correspond to the numbers of people by expenditures group and the column sums correspond to the numbers of people by demographic group. Each cell in the matrix has the number of people by the demographic group and expenditures group. The numbers are iteratively adjusted to make sure they add up to both the correct numbers of people by expenditures group and the correct numbers of people by demographic group.

The report generation engine 404 can be used to generate reports to help enable forecasting income and expenditures distributions. For example, the report generation engine 404 can generate a financial report of a country, compare two or more countries, generate forecasted income and expenditures distributions for a specific demographic of people in one or more countries, or other reports to help enable forecasting income and expenditures distributions.

Turning to FIG. 5, FIG. 5 is a simplified block diagram illustrating example details of a particular non-limiting implementation of the database 116 of FIG. 1. The database 116 can include household spending and income data 502, survey data 504, and one or more reports 506. Note that the database 116 can include other data obtained from one or more data sources 130, intermediate data used by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404, or other data used by the system to help enable forecasting income and expenditures distributions.

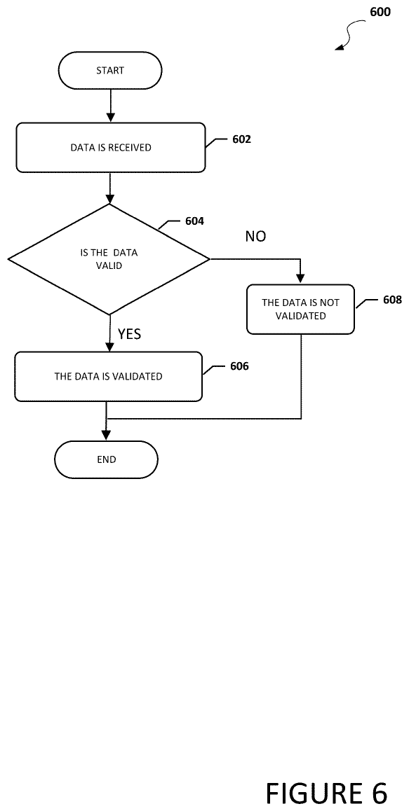

Turning to FIG. 6, FIG. 6 is an example flowchart illustrating possible operations of a flow 600 that may be associated with potential operations to help validate data to help enable forecasting income and expenditures distributions, in accordance with an embodiment of the present disclosure. Specifically, in some examples, one or more operations of flow 600 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 602, data is received. For example, the data can be received from one or more data sources 130. The data can be relevant data that will be included in helping to enable forecasting income and expenditures distributions. At 604, the system determines if the data is valid. For example, the data can be from a known trustworthy source and/or analyzed to determine if the data is the correct type of data and does not include any egregious anomalies or errors. For example, a trustworthy source may be the WB, the IIASA, the IMF, the OECD, the I2D2, or some other established source of accurate data. In some examples, the data can be acquired from two or more different sources and to determine if the data is valid, the data from the two or more different sources can be compared to each other to see if they are the same or similar. If data acquired from two or more sources is similar, the data can be merged, averaged, or otherwise combined. If the data is valid, the data is validated and can be used to help enable the process of forecasting income and expenditures distributions, as in 606. If the data is not valid, the data is not validated, as in 608. Data that is not validated is disregarded and/or not used.

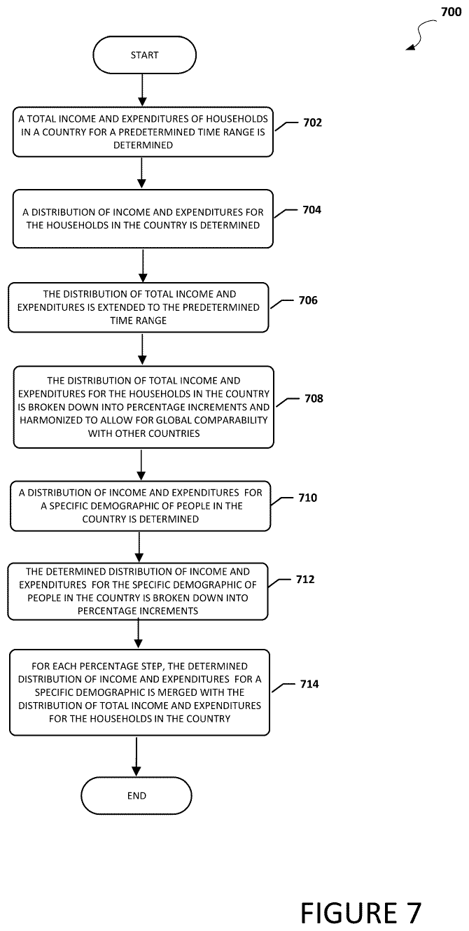

Turning to FIG. 7, FIG. 7 is an example flowchart illustrating possible operations of a flow 700 that may be associated with potential operations to help enable forecasting income and expenditures distributions, in accordance with an embodiment of the present disclosure. Specifically, in some examples, one or more operations of flow 700 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 702, the total income and expenditures of households in a country for a predetermined time range are determined. The predetermined time range can be ten prior years from the current year to fifty future years from the current year, from twenty prior years from the current year to ten future years from the current year, or some other predetermined time range, depending on user preference and system constraints. In an example, forecasts of household income and expenditure data for a total population of a country and per capita of the country can be obtained from one or more data sources 130. In some examples, the data can be validated (e.g., see FIG. 6). The data can be used to generate GDP growth rates for the country and the total household expenditures for the country can be increased based on the growth rate of the GDP. To forecast a savings rate for the country, averages of the savings rate from past years may be used. The savings rate of the country can be applied to estimate incomes based on expenditures using data from one or more data sources 130 on household savings and household disposable income. In a specific example, the savings rate is equal to the household savings divided by the household disposable income. To determine incomes based on expenditures and the savings rates, the income can be equal to expenditure divided by one minus the savings rate (income=expenditure/(1−savings rate)).

At 704, a distribution of income and expenditures for the households in the country is determined. For example, using total income and expenditure of the country from one or more data sources 130, the income distributions and expenditure distributions for the country can be broken down in percentage increments (e.g., 0.1% increments or some other percentage increment) by the distribution of income and expenditures engine 112. More specifically, the total income and expenditure of the country can be broken down such that a first percentage increment of the population of the country has “X” percent of the total income of the country (e.g., the poorest 0.1% of the population of the country has 0.05% of the total income), the next second percentage increment of the population of the country has “Y” percent of the total income (e.g., the poorest 0.2% of the population of the country has 0.1% of the total income), the third percentage increment of the population of the country has “Z” percent of the total income (e.g., the poorest 0.3% of the population of the country has 0.15% of the total income), etc. In some examples, the distributions of household income and expenditures are adjusted so that the sums of all the household income and expenditure from the corresponding distributions are equal to the total income and expenditure for the country. For countries with household expenditure data but missing household income data, the household expenditure distributions can be linked to the household income using linear regressions to forecast the missing household income data in the country. For countries with household income data but missing household expenditure data, the household income can be linked to the household expenditure using linear regressions to forecast the missing household expenditure data in the country. For countries with both missing household income data and missing household expenditure data, known household income data and/or household expenditure data from one or more countries with similar socioeconomic data can be used to estimate the missing household income data and/or the missing household expenditure data.

At 706, the distribution of total income and expenditures is extended to the predetermined time range. For example, interpolation of the household income and the household expenditure distributions in the country can be used to predict income distributions and expenditure distributions during missing years of the predetermined time range. The predetermined time range can extend after the last data observations.

At 708, the distribution of total income and expenditures for the households in the country is broken down into percentage increments and harmonized to allow for global comparability with other countries. For example, the distribution of total income and expenditures for the households in the country is parameterized and the household income and household expenditure distributions are put into monetary increments (e.g., one-dollar increments, one-euro increments, one-yen increments, etc.). More specifically, one or more parameters that describe each country's household income and household expenditure distribution can be estimated. In a non-limiting example, linear regression can be used to estimate three (or more) parameters that describe each household income and household expenditure distribution. The household income and household expenditure distributions are put into monetary increments using the total household income and household expenditures for the country and the estimated one or more parameters that describe each household income and household expenditure distribution. For example, if the monetary increments are in one-dollar increments, “X” number of people have an income of zero to one dollar ($0-$1) per day, “Y”number of people have an income of one dollar to two dollars ($1-$2) per day, etc.

At 710, a distribution of income and expenditures for a specific demographic of people in the country is determined. For example, using survey data from respondents in the country (e.g., from the I2D2), demographics can be associated with each respondent and each respondent can be assigned to an increment of the household income distributions and expenditure distributions according to the income and/or expenditures of each respondent. More specifically, in a non-limiting example, five percent increments of household income distributions and expenditure distributions can be identified (e.g., the poorest 5% of the population of the country have a maximum income of X, the poorest 10% of the population of the country have a maximum income of Y, etc.) and each of the respondents to the survey can be assigned to a five percent increment of household income and expenditure distributions.

At 712, the determined distribution of income and expenditures for the specific demographic of people in the country is broken down into percentage increments. For example, for each demographic group, the share of each percent increment of household income distributions and expenditure distributions for a specific demographic group is determined. For example, “X” percentage of a demographic group is in the poorest five percent, “Y” percentage of the demographic group is in the next poorest five percent, etc. The demographics can be age, gender, education, household size, residence location, or some other demographic, so long as there is sufficient survey data (e.g., enough respondents with the demographic) to allow the demographic to be assigned to a five percent increment of household income and expenditure distributions.

At 714, for each percentage step, the determined distribution of income and expenditures for the specific demographic is merged with the distribution of total income and expenditures for the households in the country. For example, each percentage increment of the household income distributions and expenditure distributions may or may not include a percentage of a demographic group (e.g., 6% of a demographic group may be in a specific 5% increment of the household income and expenditure distributions). By using the household income and household expenditure distributions in monetary increments the household income distributions and expenditure distributions for each demographic can be determined. In some examples, scaling is used to ensure the total number of people in each percentage increment of the household income distributions and expenditure distributions is equal to or approximately equal to the total population of the country and the total amount of household income distributions and expenditure distributions in each percentage increment is equal to or approximately equal to the total household income distributions and expenditure distributions of the country.

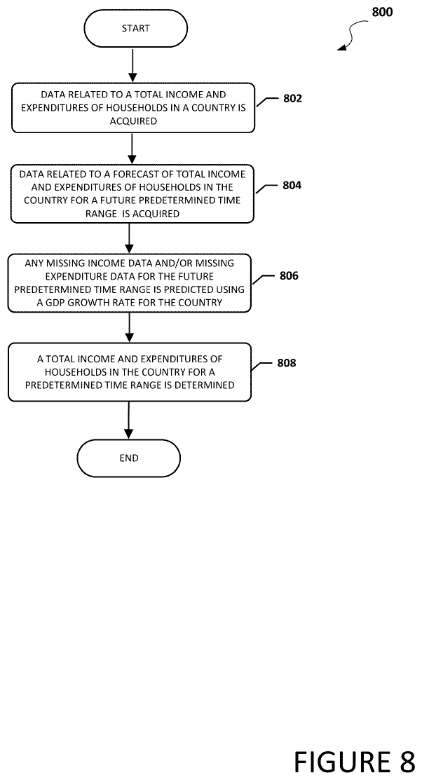

Turning to FIG. 8, FIG. 8 is an example flowchart illustrating possible operations of a flow 800 that may be associated with potential operations to help enable forecasting income and expenditures distributions, in accordance with an embodiment of the present disclosure. Specifically, in some examples, one or more operations of flow 800 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 802, data related to the total income and expenditures of households in a country is acquired. For example, data related to the total income and expenditures of households in a country can be obtained from one or more data sources 130. In some examples, the data can be validated (e.g., see FIG. 6). At 804, data related to a forecast of total income and expenditures of households in the country for a future predetermined time range is acquired. For example, forecasts of household income and expenditure data for a total population of a country and per capita of the country can be obtained. In some examples, the data can be validated (e.g., see FIG. 6). The future time range can be fifty future years from the current year, ten future years from the current year, or some other predetermined time range, depending on user preference and system constraints. At 806, any missing income data and/or missing expenditure data for the future predetermined time range is predicted using a GDP growth rate for the country. At 808, the total income and expenditures of households in the country for a predetermined time range are determined. For example, using the total income and expenditures of households in the country and the forecasts of total income and expenditures of household in the country for the future predetermined time range, the total income and expenditures of households in the country for the predetermined time range can be determined. The predetermined time range can be ten prior years from the current year to fifty future years from the current year, from twenty prior years from the current year to ten future years from the current year, or some other predetermined time range, depending on user preference and system constraints.

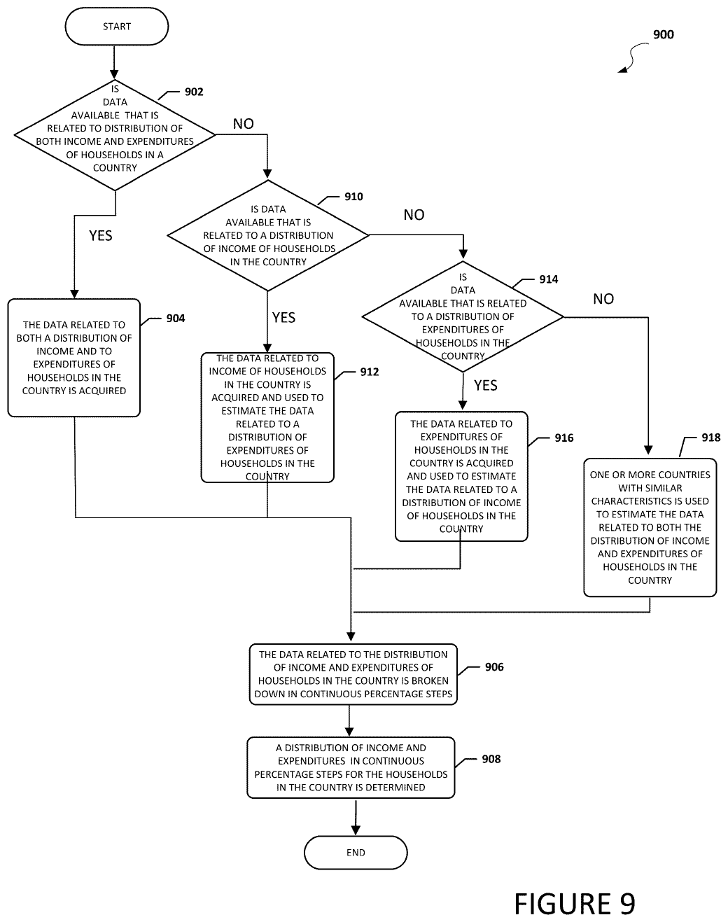

Turning to FIG. 9, FIG. 9 is an example flowchart illustrating possible operations of a flow 900 that may be associated with potential operations to help enable forecasting income and expenditures distributions, in accordance with an embodiment of the present disclosure. Specifically, in some examples, one or more operations of flow 900 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 902, the system determines if data is available that is related to both a distribution of income and a distribution of expenditures of households in a country. For example, the system determines if data from one or more data sources 130 is available that is related to both distribution of income and to expenditures of households in a country. If data is available that is related to both a distribution of income and to a distribution of expenditures of households in a country, the data related to both a distribution of income and to expenditures of households in the country is acquired, as in 904. For example, the data related to both a distribution of income and a distribution of expenditures of households in the country can be acquired from the one or more data sources 130. In some examples, the data can be validated (e.g., see FIG. 6). At 906, the data related to the distributions of income and expenditures of households in the country is broken down into continuous percentage steps. At 908, distributions of income and expenditures in continuous percentage steps for the households in the country are determined.

Going back to 902, if the system determines data is not available that is related to both a distribution of income and a distribution of expenditures of households in a country, the system determines if data is available that is related to a distribution of income of households in the country, as in 910. If data is available that is related to a distribution of income of households in the country, the data related to income of households in the country is acquired and used to estimate the data related to a distribution of expenditures of households in the country, as in 912. For example, the data related to income of households in the country is acquired from the one or more data sources 130. In some examples, the data can be validated (e.g., see FIG. 6). In addition, the data related to income of households in the country is used to estimate the data related to a distribution of expenditures of households in the country. More specifically, the household income distributions can be linked to the household expenditure distributions using linear regressions to forecast the missing household expenditure data in the country. At 906, the data related to the distributions of income and expenditures of households in the country is broken down into continuous percentage steps.

Going back to 910, if data is not available that is related to a distribution of income of households in the country, the system determines if data is available that is related to the distribution of expenditures of households in the country, as in 914. If data is available that is related to the distribution of expenditures of households in the country, the data related to the distribution of expenditures of households in the country is acquired and used to estimate the data related to a distribution of income of households in the country, as in 916. For example, the data related to income of households in the country is acquired from the one or more data sources 130. In some examples, the data can be validated (e.g., see FIG. 6). In addition, the data related to expenditures of households in the country is used to estimate the data related to a distribution of income of households in the country. More specifically, the household expenditure distributions can be linked to the household income distributions using linear regressions to forecast the missing household income data in the country. At 906, the data related to the distributions of income and expenditures of households in the country is broken down into continuous percentage steps.

Going back to 914, if data is not available that is related to the distribution of expenditures of households in the country, one or more countries with similar characteristics are used to estimate the data related to both the distribution of income and expenditures of households in the country. For countries with both missing household income data and missing household expenditure data, known household income data and/or household expenditure data from one or more countries with similar socioeconomic data can be used to estimate the missing household income data and/or the missing household expenditure data. At 906, the data related to the distribution of income and expenditures of households in the country is broken down into continuous percentage steps.

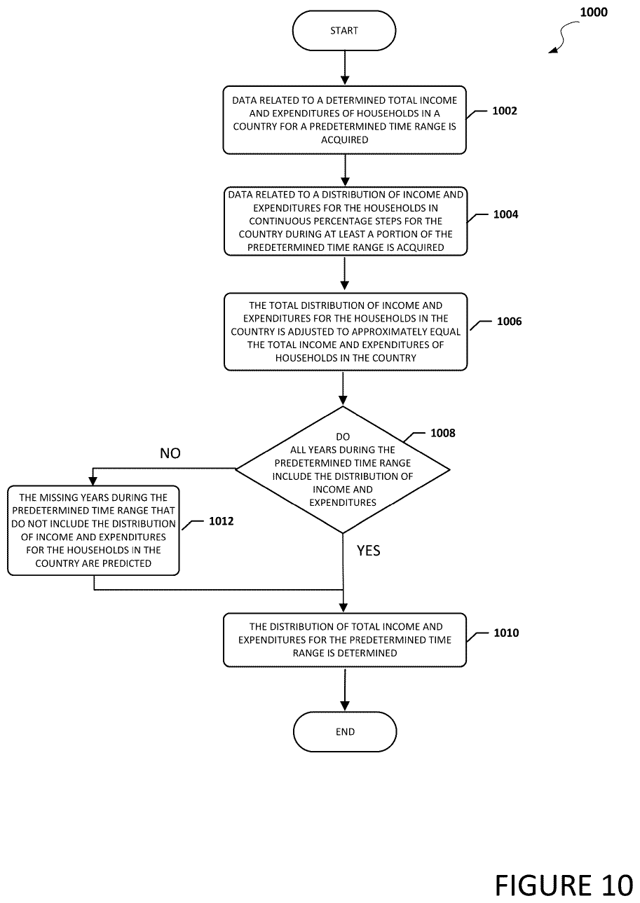

Turning to FIG. 10, FIG. 10 is an example flowchart illustrating possible operations of a flow 1000 that may be associated with potential operations to help enable forecasting income and expenditures distributions, in accordance with an embodiment of the present disclosure. Specifically, in some examples, one or more operations of flow 1000 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1002, data related to the determined total income and expenditures of households in a country for a predetermined time range is acquired. For example, forecasts of household income and expenditure data for a total population of a country can be obtained from one or more data sources 130. In some examples, the data can be validated (e.g., see FIG. 6). Interpolation of the household income and the household expenditure distributions in the country can be used to predict income distributions and expenditure distributions during missing years of the predetermined time period and allow the predetermined time range to extend after the last data observations. More specifically, the predetermined time range can be ten prior years from the current year to fifty future years from the current year, from twenty prior years from the current year to ten future years from the current year, or some other predetermined time range, depending on user preference and system constraints.

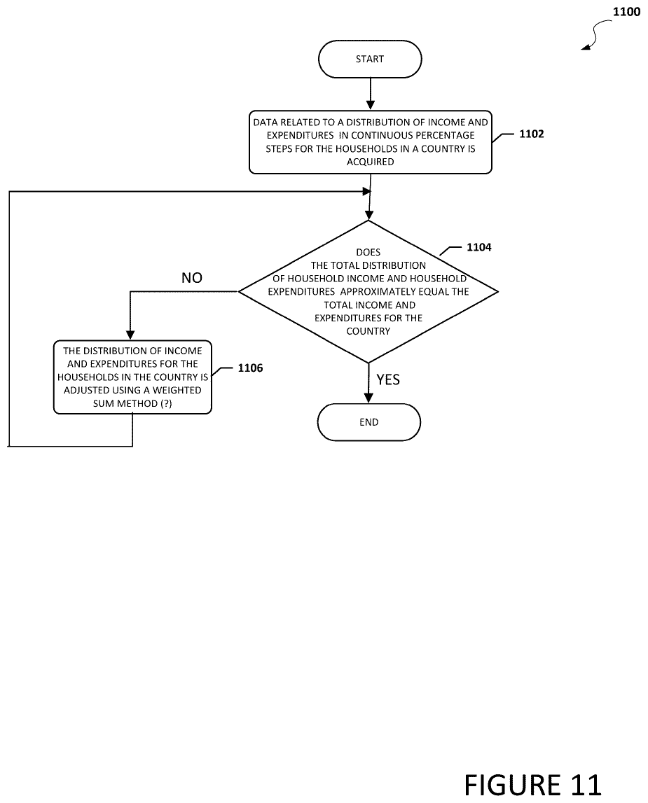

At 1004, data related to a distribution of income and expenditures for the households in continuous percentage steps for the country during at least a portion of the predetermined time range is acquired. For example, as illustrated in FIG. 9, using the distribution of income and expenditures of households in a country, a distribution of income and expenditures for the households in continuous percentage steps for the country during the predetermined time range can be determined. At 1006, the aggregate income and expenditures for the households in the country from the distributions are adjusted to approximately equal the total income and expenditures of household in the country. For example, as illustrated in FIG. 11, the distributions of household income and expenditures are adjusted so that the sums of all the household income and expenditure from the corresponding distributions is equal to the total income and expenditure for the country. In some examples, the adjustment is a weighted adjustment not a linear adjustment because if the whole distribution or all the household income distributions and expenditure distributions were scaled up to match the total income and expenditure for the country, there would not be any poor people in the country because everybody was shifted up. Instead, extra expenditures are added to the households with higher income and expenditure such that the higher a household's income or expenditure, the more it is shifted up. The process can be iteratively repeated to shift the upper end more and more until the sum of all the household income and expenditure from the corresponding distributions is equal to the total income and expenditure for the country.

At 1008, the system determines if all years during the predetermined time range include the distribution of income and expenditures. If all years during the predetermined time range do include the distribution of income and expenditures, the distribution of total income and expenditures for the predetermined time range is determined, as in 1010. If all years during the predetermined time range do not include the distribution of income and expenditures, the missing years during the predetermined time range that do not include the distribution of income and expenditures for the households in the country are predicted, as in 1012. For example, the missing years during the predetermined time range that do not include the distribution of income and expenditures for the households in the country can be predicted using interpolation.

Turning to FIG. 11, FIG. 11 is an example flowchart illustrating possible operations of a flow 1100 that may be associated with potential operations to help enable forecasting income and expenditures distributions, in accordance with an embodiment of the present disclosure. Specifically, in some examples, one or more operations of flow 1100 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1102, data related to a distribution of income and expenditures in continuous percentage steps for the households in a country is acquired. At 1104, the system determines if the total distribution of household income and household expenditures approximately equals the total income and expenditures for the country.

If the total distribution of household income and household expenditures does not approximately equal the total income and expenditures for the country, the distribution of income and expenditures for the households in the country is adjusted using a weighted sum method, as in 1106 and again, the system determines if the total distribution of household income and household expenditures approximately equals the total income and expenditures for the country, as in 1104. For example, extra expenditures are added to the households with higher income or expenditure such that the higher a household's income or expenditure, the more it is shifted up and the process is iteratively repeated until the sum of all the household income and household expenditures from the corresponding distributions approximately equals the total income and expenditures for the country and the process ends.

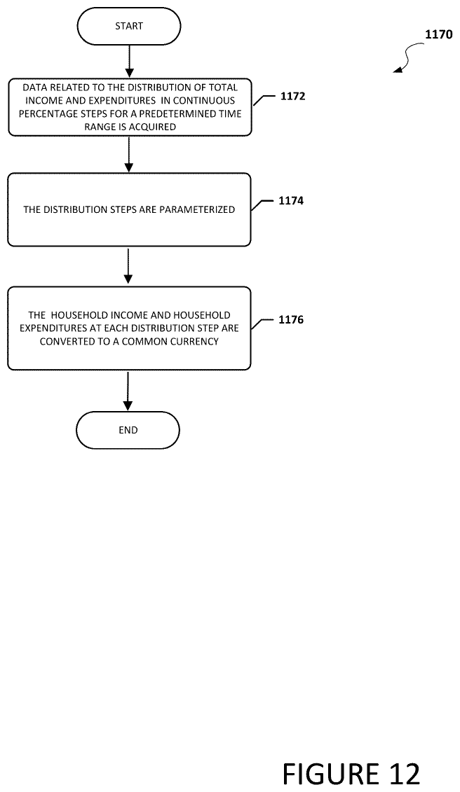

Turning to FIG. 12, FIG. 12 is an example flowchart illustrating possible operations of a flow 1200 that may be associated with potential operations to help enable forecasting income and expenditures distributions, in accordance with an embodiment of the present disclosure. Specifically, in some examples, one or more operations of flow 1200 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1202, data related to a distribution of total income and expenditures in continuous percentage steps for a predetermined time range is acquired.

At 1204, the distribution steps are parameterized. For example, parameters are used that describe the distributions in a summarizing way and transform the distribution into another format to correlate the expenditures and the population. In one specific illustrative example, for each distribution, three parameters are estimated that describe the distribution in terms of the population and the expenditures on the left and right sides of an equation. More specifically, in a specific nonlimiting example, the expenditures equal the population minus theta (first parameter), times population to the power of gamma (second parameter), times one minus the population to the power of sigma (third parameter). The three parameters can be regression parameters used in a linear regression that describes the expenditures distribution. Other means may be used to correlate the expenditures and the population.

At 1206, the household income and household expenditures at each distribution step are converted to a common currency. For example, the household income and household expenditures at each distribution step are converted into monetary increments (e.g., one-dollar increments, one-euro increments, one-yen increments, etc.). For example, if the monetary increments are in one-dollar increments, “X” people have an income of zero to one dollar ($0-$1) per day, “Y”people have an income of one dollar to two dollars ($1-$2) per day, etc.

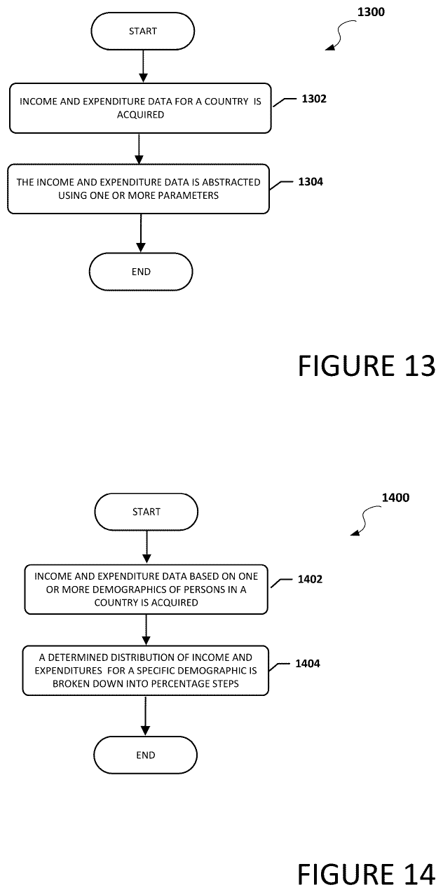

Turning to FIG. 13, FIG. 13 is an example flowchart illustrating possible operations of a flow 1300 that may be associated with potential operations to help enable forecasting income and expenditures distributions, in accordance with an embodiment of the present disclosure. Specifically, in some examples, one or more operations of flow 1300 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1302, income and expenditure data for a country is acquired. For example, the one or more data sources 130 can be used to obtain income and expenditure data for a country. At 1304, the income and expenditure data is abstracted using one or more parameters. For example, one or more parameters that describe each household income and household expenditure distribution can be estimated. In a non-limiting example, a linear regression can be used to estimate three (or more) parameters that describe each household income and household expenditure distribution. The household income and household expenditure distributions are converted into monetary increments using the total household income and household expenditures for the country and the estimated one or more parameters that describe each household income and household expenditure distribution. In a specific illustrative example, for each distribution, three parameters are estimated that describe the distribution in terms of the population and the expenditures. More specifically, in a specific nonlimiting example, the expenditures equal the population minus theta (first parameter), times population to the power of gamma (second parameter), times one minus the population to the power of sigma (third parameter). The three parameters can be regression parameters used in a linear regression that describes the expenditures distribution. Other means may be used abstract the income and expenditure data. For example, other means may be used to correlate the expenditures and the population.

Turning to FIG. 14, FIG. 14 is an example flowchart illustrating possible operations of a flow 1400 that may be associated with potential operations to help enable forecasting income and expenditures distributions, in accordance with an embodiment of the present disclosure. Specifically, in some examples, one or more operations of flow 1400 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1402, income and expenditure data based on one or more demographics of persons in a country is acquired. For example, based on surveys of persons in a country obtained from one or more data sources 130, income and expenditure data based on one or more demographics of persons in a country is acquired

At 1404, a determined distribution of income and expenditures for a specific demographic is broken down into percentage steps. For example, using survey data from respondents in the country (e.g., from a data source 130 such as the I2D2), demographics can be associated with each respondent and each respondent can be assigned to an increment of the household income distributions and expenditure distributions according to the income and/or expenditures of each respondent. More specifically, in a non-limiting example, five percent increments of household income distributions and expenditure distributions can be identified (e.g., the poorest 5% of the population of the country have a maximum income of X, the poorest 10% of the population of the country have a maximum income of Y, etc.) and each of the respondents to the survey can be assigned to a five percent increment of household income distributions and expenditure distributions. Each respondent in the survey has a weight that represents the number of people that each respondent represents or stands for. Aggregating means summing up the weights such that for each group, one number of weights represents the number of people in the group. Based on the weights, the distributions for each demographic group can be based on the shares. For each demographic group, a distribution is obtained that corresponds to the proportion of this demographic group in each segment of the household income or expenditure distribution (e.g. young men represent 35% of the poorest 5% in the country). The distribution can be applied to the national distribution to allow the distribution of income and expenditures for a specific demographic to be broken down into percentage steps.

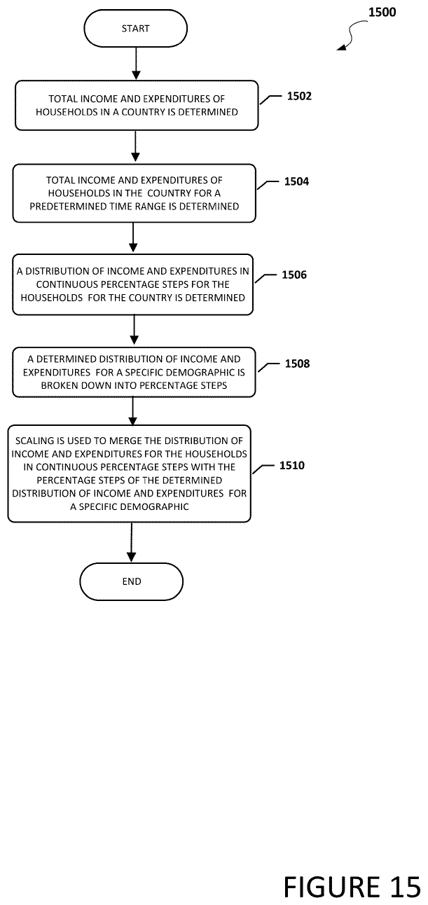

Turning to FIG. 15, FIG. 15 is an example flowchart illustrating possible operations of a flow 1500 that may be associated with potential operations to help enable forecasting income and expenditures distributions, in accordance with an embodiment of the present disclosure. Specifically, in some examples, one or more operations of flow 1500 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1502, total income and expenditures of households in a country are determined. For example, household income and expenditure data for a total population of a country can be obtained from one or more data sources 130. In some examples, the data can be validated (e.g., see FIG. 6).

At 1504, the total income and expenditures of households in a country for a predetermined time range are determined. In an example, interpolation of the household income and the household expenditure distributions in the country can be used to predict income distributions and expenditure distributions during missing years of the predetermined time period and allow the predetermined time range to extend after the last data observations. More specifically, the predetermined time range can be ten prior years from the current year to fifty future years from the current year, from twenty prior years from the current year to ten future years from the current year, or some other predetermined time range, depending on user preference and system constraints.

At 1506, a distribution of income and expenditures in continuous percentage steps for the households in the country is determined. For example, as illustrated in FIG. 9, using the distribution of income and expenditures of households in a country, a distribution of income and expenditures for the households in continuous percentage steps for the country during the predetermined time range can be determined.

At 1508, a determined distribution of income and expenditures for a specific demographic is broken down into percentage steps. For example, using survey data from respondents in the country (e.g., from a data source 130 such as the I2D2), demographics can be associated with each respondent and each respondent can be assigned to an increment of the household income distributions and expenditure distributions according to the income and/or expenditures of each respondent. More specifically, in a non-limiting example, five percent increments of household income distributions and expenditure distributions can be identified (e.g., the poorest 5% of the population of the country have a maximum income of “X”, the poorest 10% of the population of the country have a maximum income of “Y”, etc.) and each of the respondents to the survey can be assigned to a five percent (5%) increment of household income distributions and expenditure distributions. Each respondent in the survey has a weight that represents the number of people that each respondent represents or stands for. Aggregating means summing up the weights such that for each group, one number of weights represents the number of people in the group. Based on the weights, the distributions for each demographic group can be based on the shares. For each demographic group, a distribution is obtained that corresponds to the proportion of this demographic group in each segment of the household income or expenditure distribution (e.g. young men represent 35% of the poorest 5% in the country). The distribution can be applied to the national distribution to allow the distribution of income and expenditures for a specific demographic to be broken down into percentage step.

At 1510, scaling is used to merge the distribution of income and expenditures for the households in continuous percentage steps with the percentage steps of the determined distribution of income and expenditures for a specific demographic to create a distribution of income and expenditures for a specific demographic. For example, the scale distributions engine 402 can be configured to scale and merge the distribution of income and expenditures for the households in continuous percentage steps with the percentage steps of the determined distribution of income and expenditures for a specific demographic to create a distribution of income and expenditures for a specific demographic.

Adding up the combined information that gives the number of people per expenditures group for one or more demographics will not necessarily equal the total number of people per expenditures group. Adding the percentage steps might either match the population numbers, like the total number of people aged “X” (e.g., 0-10) or might match the correct number of people in the expenditures group ($0-$5) but, it will not match both. The scaling is for making sure the determined distribution of income and expenditures for a specific demographic matches the distribution of income and expenditures for the households.

The scaling is done iteratively until the distribution of income and expenditures for the households in continuous percentage steps is approximately equal to the percentage steps of the determined distribution of income and expenditures for a specific demographic. In a specific example, a matrix may be used where the row sums correspond to the numbers of people by expenditure group and the column sums correspond to the numbers of people by demographic group. Each cell in the matrix has the number of people by the demographic group and expenditures group. The numbers are iteratively adjusted to make sure they add up to both the correct numbers of people by the expenditures group and the correct numbers of people by demographic group.

In a specific example, the scale distributions engine 402 is configured to scale the cells in the matrix to the total number of people per expenditures and to the total number of people per demographic group. In some examples, a multiplication factor is used to try and match the number of people by expenditure and demographic group to the total number of people per expenditures group and another multiplication factor is used to try and match them to the total number of people per demographic group. The scale distributions engine 402 can iteratively scale the distributions and with each iteration, the errors become smaller and smaller until the errors are negligible. Note that the numbers may not exactly match and a one percent (1%) error may be acceptable. In some examples after one-hundred (100) iterations, the scaling stops.

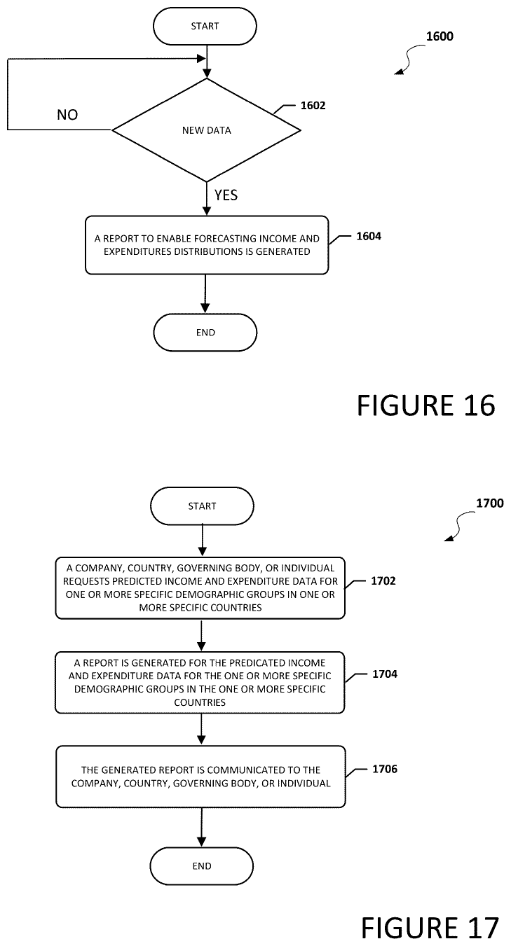

Turning to FIG. 16, FIG. 16 is an example flowchart illustrating possible operations of a flow 1600 that may be associated with potential operations to help enable forecasting income and expenditures distributions, in accordance with an embodiment of the present disclosure. Specifically, in some examples, one or more operations of flow 1600 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1602, the system determines if new data is available. For example, the new data may be updated data from one or more data sources 130. If new data is available, then a report to enable forecasting income and expenditures distributions is generated, as in 1604. If new data is not available, the system returns to 1602 and checks again for new data. In some examples, the system can check for new day every hour, every day, every week, every month, every six months, etc.

Turning to FIG. 17, FIG. 17 is an example flowchart illustrating possible operations of a flow 1700 that may be associated with potential operations to help enable forecasting income and expenditures distributions, in accordance with an embodiment of the present disclosure. Specifically, in some examples, one or more operations of flow 1700 may be performed by the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404. At 1702, a company, country, governing body, or individual requests predicted income and expenditure data for one or more specific demographic groups in one or more specific countries. For example, a retail company may request predicted income and expenditure data for women aged sixteen (16) to thirty (30) in India to try and estimate future cosmetic sales in India. In another example, a non-profit company that helps fight poverty may request income and expenditure data for people in rural areas of one or more countries to make poverty predictions for the rural areas of the one or more countries. In yet another example, a governing body may request predicted income and expenditure data for registered votes in a specific country to help create a policy platform. In still yet another example, a company may request predicted income and expenditure data for parents in the top twenty-five percent (25%) income bracket in China with children under five (5) years of age.

At 1704, a report is generated for the predicated income and expenditure data for the one or more specific demographic groups in the one or more specific countries. At 1706, the generated report is communicated to the company, country, governing body, or individual. In some examples, the report is electronically communicated to the company, country, governing body, or individual.

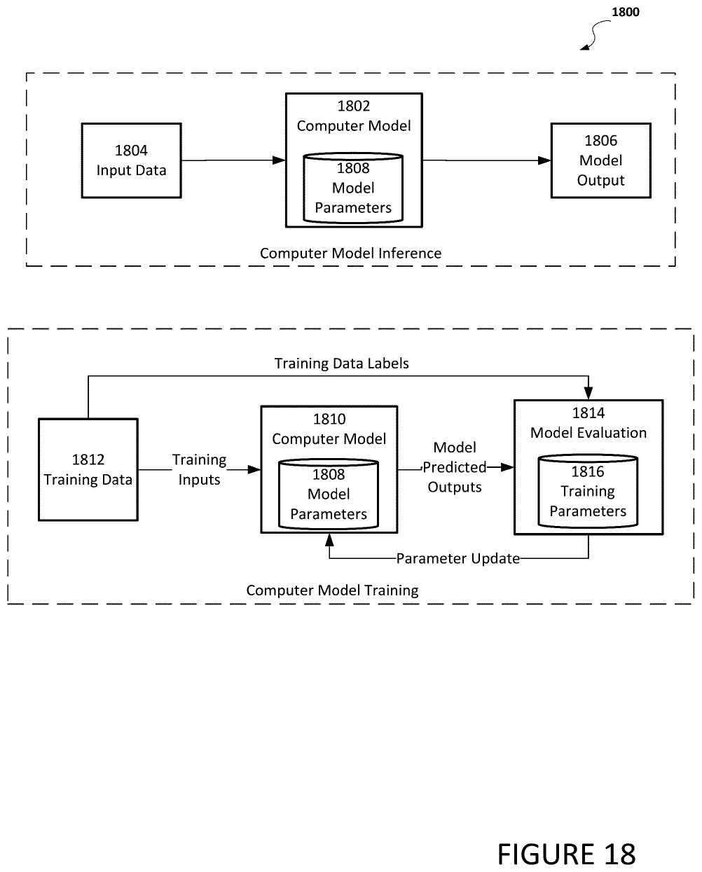

Turning to FIG. 18, FIG. 18 illustrates example computer model inference, sometimes referred to as machine learning, and computer model training 1800. Computer model inference refers to the operationalization of a trained machine learning model. Computer model inference refers to the application of a computer model 1802 to a set of input data 1804 to generate an output or model output 1806. The computer model 1802 determines the model output 1806 based on parameters of the model, also referred to as model parameters 1808. The parameters of the model may be determined based on a training process that finds an optimization of the model parameters 1808, typically using training data and desired outputs of the model for the respective training data as discussed below. The output (e.g., a country's total household income and expenditure) of the computer model 1802 may be referred to as an “inference” because it is a predictive value based on the input data 1804 and based on previous example data used in the model training.

The input data 1804 and the model output 1806 vary according to the particular use case. For example, to use socioeconomic data to forecast a country's total household income and expenditure, the input data 1804 may be data from one or more data sources 130 and the output or “inference” may be a forecast a country's total household income and expenditure. For computer vision and image analysis, the input data 1804 may be an image having a particular resolution, such as 75×75 pixels, or a point cloud describing a volume. In other applications, the input data 1804 may include a vector, such as a sparse vector, representing information about an object. For example, in recommendation systems, such a vector may represent user-object interactions, such that the sparse vector indicates individual items positively rated by a user. In addition, the input data 1804 may be a processed version of another type of input object, for example representing various features of the input object or representing preprocessing of the input object before input of the object to the computer model 1802. As one example, a 1024×1024 resolution image may be processed and subdivided into individual image portions of 64×64, which are the input data 1804 processed by the computer model 1802. As another example, the input object, such as a sparse vector discussed above, may be processed to determine an embedding or another compact representation of the input object that may be used to represent the object as the input data 1804 in the computer model 1802. Such additional processing for input objects may themselves be learned representations of data, such that another computer model processes the input objects to generate an output that is used as the input data 1804 for the computer model 1802. Although not further discussed here, such further computer models may be independently or jointly trained with the computer model 1802. As noted above, the model output 1806 may depend on the particular application of the computer model 1802, for example, to forecast a country's total household income and expenditure.

The computer model 1802 includes various model parameters 1808, as noted above, that describe the characteristics and functions that generate the model output 1806 from the input data 1804. In particular, the model parameters 1808 may include a model structure, model weights, and a model execution environment. The model structure may include, for example, the particular type of computer model 1802 and its structure and organization. For example, the model structure may designate a neural network, which may be comprised of multiple layers, and the model parameters 1808 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1802 processes the input data 1804 to the model output 1806. Each portion or layer of the computer model 1802 may have such weights. For example, weights may be used to determine values for processing inputs to determine outputs at a particular portion of a model. Stated another way, for example, model weights may describe how to combine or manipulate values of the input data 1804 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 1802. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1802 may be implemented on different types of circuitries. As discussed below, training of the model may include optimizing the types of hardware used for certain aspects of the computer model 1802 (e.g., co-trained), or may be determined after other parameters for the computer model 1802 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1808 for the computer model 1810. During training, the model parameters 1808 are optimized to “learn” values of the model parameters (such as individual weights, activation values, model execution environment, etc.), that improve the model parameters 1808 based on an optimization function that seeks to improve a cost function (also sometimes termed a loss function). Before training, the computer model 1810 has model parameters 1808 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1812 includes a data set to be used for training the computer model 1810. The data set varies according to the particular application and purpose of the computer model 1810. In supervised learning tasks, the training data 1812 typically includes a set of training data labels that describe the training data 1812 and the desired output of the model relative to the training data 1812. For example, for an object classification task, the training data 1812 may include individual images in which individual portions, regions or pixels in the image are labeled with the classification of the object. For this task, the training data 1812 may include a training data image depicting a dog and a person and a training data labels that label the regions of the image that include the dog and the person, such that the computer model 1810 is intended to learn to also label the same portions of that image as a dog and a person, respectively. In another example, the training data 1812 may include various total household income and expenditures of a country such that the computer model 1810 is intended to learn to forecast total household income and expenditures.

To train the computer model 1810, a training module (not shown) applies the training inputs to the computer model 1810 to determine the outputs predicted by the model for the given training inputs. The training module, though not shown, is a computing module used for performing the training of the computer model 1810 by executing the computer model 1810 according to its inputs and outputs given the model's parameters and modifying the model parameters based on the results. The training module may apply the actual execution environment of the computer model 1810, or may simulate the results of the execution environment, for example to estimate the performance, runtime, memory, or circuit area (e.g., if specialized hardware is used) of the computer model 1810. The training module, along with the training data 1812 and model evaluation, may be instantiated in software and/or hardware by one or more processing devices. In various examples, the training process may also be performed by multiple computing systems in conjunction with one another, such as distributed/cloud computing systems. In some examples the training of the computer module 1810 may be different if the computer model 1810 is a large language model (LLM). A LLM is used for language-based tasks, whereas the general Al model can be used for a variety of other tasks.

After processing the training inputs according to the current model parameters for the computer model 1810, the model's predicted outputs are evaluated and the computer model 1810 is evaluated with respect to the cost function and optimized using an optimization function of the training model. Depending on the optimization function, particular training process and training parameters 1816 after the model evaluation are updated to improve the optimization function of the computer model 1810. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1810 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1810 structure and execution environment (e.g., to evaluate or modify these model parameters).

After determining results of the cost function, the optimization function determines a modification of the model parameters to improve the cost function for the training data 1812. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1816 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1812 is batched and the parameter updates are iteratively applied to batches of the training data 1812. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1812 available or the incremental improvements in model parameters are below a threshold (e.g., additional training data 1812 no longer continues to improve the model parameters). Additional training parameters 1816 may describe the batch size for the training data 1812, a portion of training data 1812 to use as validation data, the step size of parameter updates, a learning rate of the model, and so forth. Additional techniques may also be used to determine global optimums or address nondifferentiable model parameter spaces.

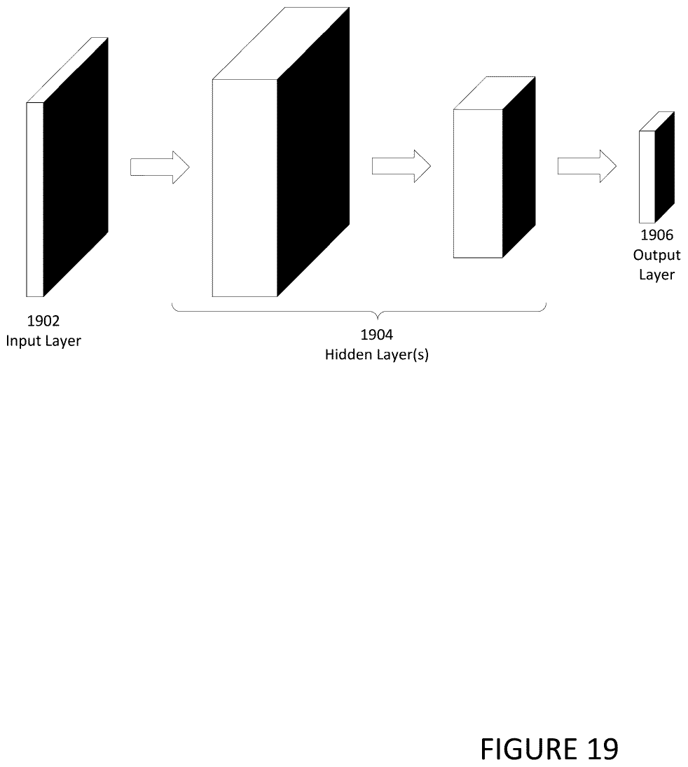

Turning to FIG. 19, FIG. 19 illustrates an example neural network architecture. In general, a neural network includes an input layer 1902, one or more hidden layers 1904, and an output layer 1906. The values for data in each layer of the network is generally determined based on one or more prior layers of the network. Each layer of a network generates a set of values, termed “activations” that represent the output values of that layer of a network and may be the input to the next layer of the network. For the input layer 1902, the activations are typically the values of the input data, although the input layer 1902 may represent input data as modified through one or more transformations to generate representations of the input data. For example, in recommendation systems, interactions between users and objects may be represented as a sparse matrix. Individual users or objects may then be represented as an input layer 1902 as a transformation of the data in the sparse matrix relevant to that user or object. The neural network may also receive the output of another computer model (or several), as its input layer 1902, such that the input layer 1902 of the neural network shown in FIG. 19 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1906 of the network.

Each layer of the neural network typically represents its output activations (i.e., also termed its outputs) in a matrix, which may be 1, 2, 3, or n-dimensional according to the particular structure of the network. As shown in FIG. 19, the dimensionality of each layer may differ according to the design of each layer. The dimensionality of the output layer 1906 depends on the characteristics of the prediction made by the model. For example, a computer model for multi-object classification may generate an output layer 1906 having a one-dimensional array in which each position in the array represents the likelihood of a different classification for the input layer 1902. In another example for classification of portions of an image, the input layer 1902 may be an image having a resolution, such as 512×512, and the output layer may be a 512×512xn matrix in which the output layer 1906 provides n classification predictions for each of the input pixels, such that the corresponding position of each pixel in the input layer 1902 in the output layer 1906 is an n-dimensional array corresponding to the classification predictions for that pixel.

The hidden layers 1904 provide output activations that variously characterize the input layer 1902 in various ways that assist in effectively generating the output layer 1906. The hidden layers thus may be considered to provide additional features or characteristics of the input layer 1902. Though two hidden layers are shown in FIG. 19, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1906. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1902 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/-20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable forecasting income and expenditures distributions in that any suitable arrangements, chronologies, configurations, and timing mechanisms may be provided without departing from the teachings of the present disclosure.

Note that embodiments of the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the nodes, the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404, etc. of the system can also include suitable interfaces for receiving, transmitting, and/or otherwise communicating data or information in a network environment.

The income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404 and other associated or integrated components can include one or more memory elements for storing information to be used in achieving operations associated with enabling forecasting income and expenditures distributions, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling obtaining additional information related to enabling forecasting income and expenditures distributions, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out enabling forecasting income and expenditures distributions described in this Specification. Regarding a physical implementation of the income and expenditures per household engine 110, the distribution of income and expenditures engine 112, the merge income and expenditures with distribution of income and expenditures engine 114, the predict missing income and/or expenditures engine 202, the predict missing years engine 204, the percentage breakdown engine 206, the data correction engine 208, the aggregate national distribution engine 302, the demographics distribution engine 304, the scale distributions engine 402, and/or the report generation engine 404 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable forecasting income and expenditures distributions and their teachings are readily scalable and can accommodate a large number of components, as well as more complicated/sophisticated arrangements and configurations. Accordingly, the examples provided should not limit the scope or inhibit the broad teachings of the system, apparatus, and method to enable forecasting income and expenditures distributions and as potentially applied to a myriad of other architectures.

It is also important to note that the operations in the preceding flow diagrams (i.e., FIGS. 11-17) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

1. A method, comprising:
collecting household income and expenditures data for a country;
collecting distribution demographic data for two or more demographic groups in the country; and
merging the household income and expenditures data and the distribution demographic data for the country to create a report forecasting income and expenditures distributions for the country, wherein the report forecasting income and expenditures distributions for the country includes a percentage step distribution across an entire population of the two or more demographic groups in the country.

2. The method of claim 1, further comprising:
before merging the household income and expenditures data with the distribution demographic data for the country:
determining a period of time;
extending the household income and expenditures data for the country for each year in the period of time wherein missing income data and/or missing expenditure data for the period of time is predicted using a gross domestic product (GDP) growth rate for the country; and
extending the distribution demographic data for the country for each year in the period of time.

3. The method of claim 1, wherein the household income and expenditures data for the country is determined by:
collecting national household income and expenditures data for the country;
forecasting income and expenditures of households in the country; and
balancing the income and expenditure of households in the country with the national household income and expenditures such that a total distribution of household income and household expenditures in the country is approximately equal to a total income and expenditures for the country.

4. The method of claim 3, wherein machine learning or a computer model is used to balance the income and expenditure of households in the country with the national household income and expenditures.

5. The method of claim 1, before merging the household income and expenditures data with the distribution demographic data for the country:
breaking down the household income and expenditures data for the country into first percentage steps; and
breaking down the distribution demographic data into second percentage steps, wherein the first percentage steps are different than the second percentage steps.

6. The method of claim 1, further comprising:
creating a second report forecasting income and expenditures distributions for a second country for the two or more demographic groups, wherein the report forecasting income and expenditures distributions for the second country includes the percentage step distribution across the entire population of the two or more demographic groups in the second country to allow the report forecasting income and expenditures distributions for the country to be compared to the report forecasting income and expenditures distributions for the second country.

7. The method of claim 1, further comprising:
checking for and collecting updated household income and expenditures data for the country and/or updated distribution demographic data for the country; and
merging the updated household income and expenditures data and/or the updated distribution demographic data for the country to create a new report and enable forecasting income and expenditures distributions for the country.

8. A system, comprising:
memory;
at least one processor;
an income and expenditures per household engine configured to collect household income and expenditures data for a country;
a distribution of income and expenditures engine configured to collect distribution demographic data for two or more demographic groups in the country; and
a merge household income and expenditures with distribution of income and expenditures engine configured to merge the household income and expenditures data and the distribution demographic data for the country to create a report forecasting income and expenditures distributions for the country, wherein the report forecasting income and expenditures distributions for the country includes a percentage step distribution across an entire population of the two or more demographic groups in the country.

9. The system of claim 8, wherein before merging the household income and expenditures data with the distribution demographic data for the country:
a period of time is determined;
the income and expenditures per household engine is further configured to extend the household income and expenditures data for the country for each year in the period of time, wherein missing income data and/or missing expenditure data for the period of time is predicted using a gross domestic product (GDP) growth rate for the country; and
the distribution of income and expenditures engine is further configured to extend the distribution demographic data for the country for each year in the period of time.

10. The system of claim 8, wherein the household income and expenditures data for the country is determined by:
collecting national household income and expenditures data for the country;
forecasting income and expenditures of households in the country; and
balancing the income and expenditure of households in the country with the national household income and expenditures of the country such that a total distribution of household income and household expenditures in the country is approximately equal to a total income and expenditures for the country.

11. The system of claim 10, wherein machine learning or a computer model is used to balance the income and expenditure of households in the country with the national household income and expenditures.

12. The system of claim 8, wherein before merging the household income and expenditures data with the distribution demographic data for the country, the household income and expenditures data for the country is broken down into first percentage steps and the distribution demographic data is broken down into second percentage steps, wherein the first percentage steps are different than the second percentage steps.

13. The system of claim 8, further comprising:
creating a second report forecasting income and expenditures distributions for a second country for the two or more demographic groups, wherein the report forecasting income and expenditures distributions for the second country includes the percentage step distribution across the entire population of the two or more demographic groups in the second country to allow the report forecasting income and expenditures distributions for the country to be compared to the report forecasting income and expenditures distributions for the second country.

14. The system of claim 8, wherein the system is configured to check for and collect updated household income and expenditures data for the country and/or updated distribution demographic data for the country and merge the updated household income and expenditures data and/or the updated distribution demographic data for the country to create a new report and enable forecasting income and expenditures distributions for the country.

15. A method, comprising:
collecting household income and expenditures data for a country;
extending the household income and expenditures data for the country for each year in a period of time, wherein missing income data and/or missing expenditure data for the period of time is predicted using a gross domestic product (GDP) growth rate for the country;
collecting distribution demographic data for two or more demographic groups in the country;
extending the distribution demographic data for the country for each year in the period of time;
merging the household income and expenditures data and the distribution demographic data for the country to create a report forecasting income and expenditures distributions for the country, wherein the report forecasting income and expenditures distributions for the country includes a percentage step distribution across an entire population of the two or more demographic groups in the country; and
creating a second report forecasting income and expenditures distributions for a second country for the two or more demographic groups, wherein the report forecasting income and expenditures distributions for the second country includes the percentage step distribution across the entire population of the two or more demographic groups in the second country to allow the report forecasting income and expenditures distributions for the country to be compared to the report forecasting income and expenditures distributions for the second country.

16. The method of claim 15, wherein the period of time is greater than ten (10) years in the future.

17. The method of claim 15, further comprising:
balancing the income and expenditure of households in the country with national household income and expenditures of the country such that a total distribution of household income and household expenditures in the country is approximately equal to a total income and expenditures for the country.

18. The method of claim 17, wherein machine learning or a computer model is used to balance the income and expenditure of households in the country with the national household income and expenditures.

19. The method of claim 15, wherein the report forecasting income and expenditures distributions for the country is compared to one or more similar reports for other countries.

20. The method of claim 15, further comprising:
checking for and collecting updated household income and expenditures data for the country and/or updated distribution demographic data for the country; and
merging the updated household income and expenditures data and/or the updated distribution demographic data for the country to create a new report and enable forecasting income and expenditures distributions for the country.
